(19) United States
(12) Patent Application Publication
(10) Pub. No.: US 2009/0308694 A1
(43) Pub. Date: Dec. 17, 2009

(54) STAIRLIFTS

(76) Inventors: Andreas Csaba Szentistvany, Hampshire (GB); Alan Neil Russell Stannah, Hampshire (GB)

Correspondence Address: NIXON & VANDERHYE, PC, 901 NORTH GLEBE ROAD, 11TH FLOOR, ARLINGTON, VA, 22203, US

(21) Appl. No.: 12/223,720

(22) PCT Filed: Feb. 9, 2007
(86) PCT No.: PCT/GB2007/000481

§ 371 Date: Nov. 25, 2008

(30) Foreign Application Priority Data
Feb. 9, 2006 (GB) 0602618.1

(51) Int. Cl. B66B 9/08

(52) U.S. Cl. 187/201

(57) ABSTRACT

The present invention provides a stairlift assembly in which the stairlift chair can be tilted forward and backward to compensate for sections of the stairlift rail being slightly out of vertical. According to the invention tilting is achieved by a novel form of interface which is mounted between the chair and the stairlift carriage. Thus the tilt function need only be provided as and when needed.

### FIELD OF THE INVENTION

This invention relates to stairlifts and, in particular, to a method of and/or means for, maintaining the chair of a stairlift assembly level as the stairlift carriage moves along a curved rail.

### BACKGROUND TO THE INVENTION

It is well known that, as a stairlift carriage moves through a transition bend (a bend in a vertical plane) on a stairlift rail, the chair, which is mounted on the carriage, must be repositioned to ensure that the seat surface of the chair remains level at all times. In traditional stairlift assemblies such levelling was effected mechanically, either by tilting the chair with respect to the carriage and rail, or by titling the entire chair and carriage assembly with respect to the rail.

More recently stairlifts have been developed in which the chair is levelled by a dedicated levelling motor under electronic control. One such form of levelling is described in our European Patent 0 738 232.

Whilst the need to level in the direction of travel has long been recognised, we have observed that the chairs of some stairlift assemblies tilt to a noticeable extent in other directions, particularly forward and back. Typically such tilting occurs as the carriage moves through inside/outside bends (bends in a horizontal plane) and through helical bends, but tilting may occur at other positions of the carriage on the rail.

For example, limitations arising in the manufacture of a stairlift rail mean that, in some instances, the intended vertical axis of the rail will not be aligned exactly vertically over the entire length of the rail. This lack of true verticality will lead to the tilting mentioned above. Tilting may also occur due to ‘give’ or flexibility in the system, as a load is applied to the chair.

Verticality issues can also arise during installation. Often when a new installation is brought to site, it is discovered that some of the staircase treads on which the rail is to be mounted, are not level. As a consequence the installer must use packing in an attempt to restore verticality to within acceptable tolerances.

Regardless of how the lack of verticality might arise, the consequences are exacerbated by the recent tendency to reduce the vertical dimension of the rail, thereby reducing the physical and visual impact of the rail. The smaller the vertical dimension of the rail, the less the spacing between the carriage rollers engaging upper and lower parts of the rail respectively. This means that small out-of-vertical deviations of the rail can translate into significant titling of the carriage and chair, in a direction perpendicular to the direction of travel of the carriage.

The problem of levelling a stairlift chair, in a direction transverse to the direction of travel of the stairlift, has been addressed in the past. International Patent Application WO 96/15974 shows a stairlift chair and carriage assembly in which the chair is mounted on a sub-frame which carries three motors. One of the motors is configured to level the chair, in the conventional manner, in the direction of movement of the stairlift carriage along the rail. One of the two remaining motors is configured to level the chair in a direction transverse to the direction of movement of the carriage, whilst the third motor is configured to translate the chair along a sloping axis. The construction described is quite complex and, since all levelling functions are included in the one assembly, in those installations where the transverse levelling and translation are not required, unnecessary expense would be incurred in providing redundant components.

In our pending British Patent Application No 2 409 446 we describe an alternative arrangement for providing transverse levelling. This arrangement is considerably simpler than that described in WO 96/15974 but is included in the structure of the roller assembly which attaches the carriage to the rail. Thus the provision of transverse levelling according to GB 2 409 446 either requires a dedicated form of carriage, or the provision of a carriage in which, in some installations, significant features will be redundant.

It is an object of this invention to provide a method of, and means for, providing a stairlift installation which will go at least some way in addressing the concerns expressed above; and, in particular, will allow for transverse levelling of a stairlift chair as and when required; or which will at least provide a novel and useful choice.

### SUMMARY OF THE INVENTION

Accordingly, in a first aspect, the invention provides a method of tilting a stairlift chair which is provided in an assembly including:
a stairlift rail;
a carriage mounted for movement along said rail;
a stairlift chair; and
a chair interface between said chair and said carriage to mount said chair on said carriage;
said method being characterised in that it comprises altering the configuration of said chair interface to tilt said chair with respect to said carriage.

Preferably said method further includes sensing the level of said chair as said carriage moves along said rail, and altering the configuration of said chair interface in response to such sensing, if necessary, to restore the chair substantially to the level.

Alternatively, said method further includes storing in an electronic memory information representing the desired alignment of the chair at various positions of the carriage along the rail and, as the carriage reaches a particular position on the rail, causing control means acting in response to the information in said memory to effect a change of configuration of said chair interface to achieve said desired alignment.

In a second aspect, the invention provides a stairlift assembly including:
a stairlift rail;
a carriage mounted for movement along said rail;
a stairlift chair;
a chair interface between said chair and said carriage to mount said chair on said carriage,
said assembly being characterised in that the configuration of said chair interface is alterable to effect tilting of said chair with respect to said carriage.

Preferably said interface includes two parts pivoted together to form scissor arms, one of said scissor arms being mounted to said carriage and the other of said scissor arms being mounted to said chair.

Preferably said interface further includes an electric motor to, in use, effect alteration of the configuration of said interface.

In a third aspect the invention provides a chair interface for mounting between a stairlift carriage and a stairlift chair, said chair interface being characterized in that the configuration thereof can, in use, be altered to effect tilting of said chair with respect to said carriage.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof.

### BRIEF DESCRIPTION OF THE DRAWINGS

One operating embodiment of the invention will now be described with reference to the accompanying drawings in which:

FIG. 1: shows an isometric view of a first form of stairlift chair interface according to the invention;

FIGS. 2A & 2B: show side elevations of the interface shown in FIG. 1 in place between a stairlift chair and a stairlift carriage, in two different configurations;

FIGS. 3A & 3B: show isometric views of parts of a second form of chair interface according to the invention, in two different configurations;

FIGS. 4A & 4B: show side elevations of the interface shown in FIGS. 3A & 3B in place between a stairlift chair and a stairlift carriage; and

FIGS. 5A & 5B: show rear isometric views of a third form of chair interface according to the invention in place between a stairlift carriage and a stairlift chair, in two different configurations.

### DETAILED DESCRIPTION OF WORKING EMBODIMENT

The present invention provides a method of, and means for, establishing a level seat surface for a stairlift chair in a direction perpendicular to the direction of travel of a stairlift chair and carriage along a stairlift rail. Levelling in the direction of travel is entirely conventional and has been practised for so long as curved stairlifts have existed. Levelling in the orthogonal direction is less common though has been described in our British Patent Application GB 2 409 446.

In the description which follows, the method and apparatus is only concerned with levelling perpendicular to the direction of travel i.e. tilting the chair forward and back. It is assumed that conventional levelling in the direction of travel will be effected by any one of many existing levelling systems known in the art, one example of which is described and claimed in European Patent 0 738 232. It should be appreciated, however, that suitable adaptations of the present invention could effect chair levelling both in the direction of travel of the stairlift, as well as tilting in a direction perpendicular to the direction of travel.

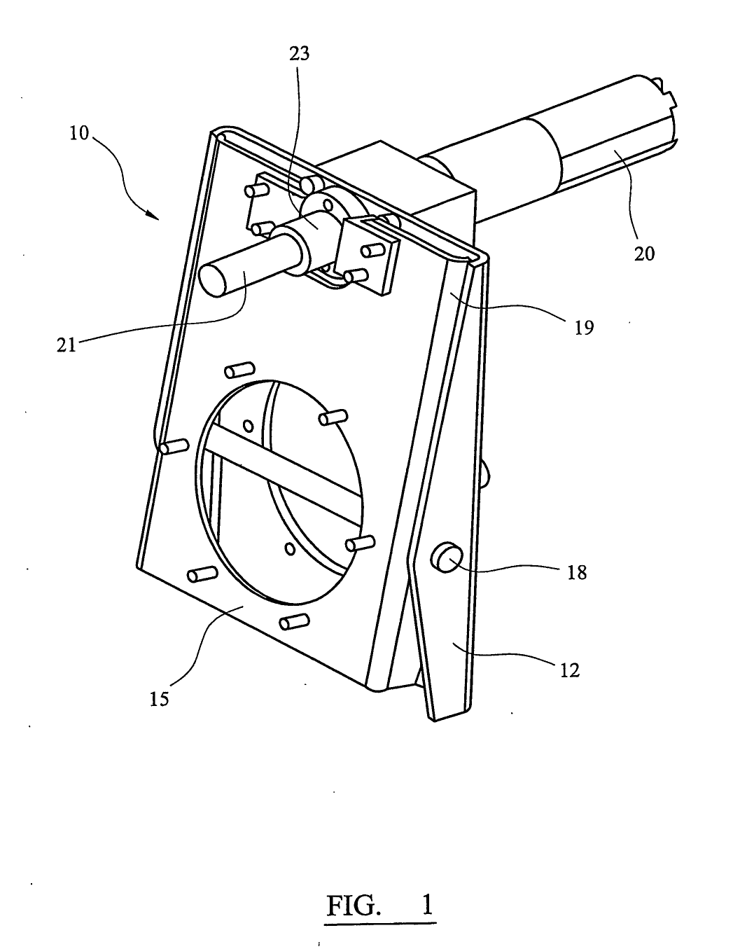

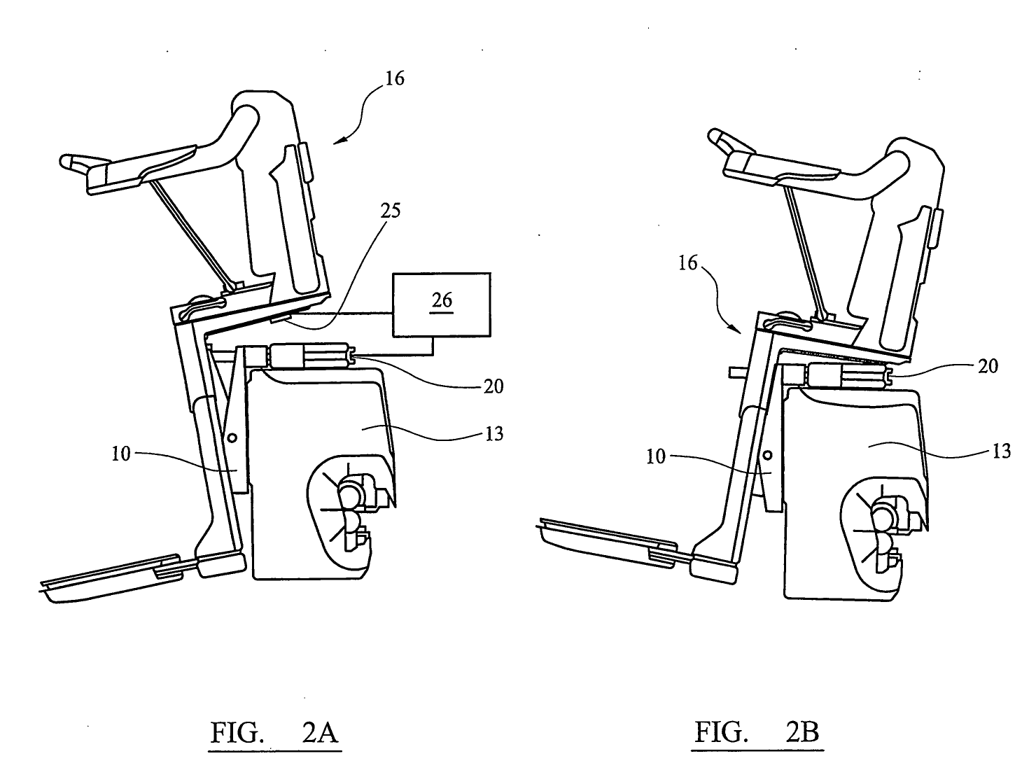

Referring firstly to FIG. 1, a chair interface 10 is shown having a first section 12 mountable on a stairlift carriage 13 (FIGS. 2A, 2B) and a second section 15 serving as a mounting point for a stairlift chair 16. In the form shown the sections 12 and 15 are mounted on a common pivot shaft 18 and thus move with respect to one another in a scissor-type action. By moving the upper edge 19 of section 15 toward and away from section 12, about pivot 18, a chair 16 mounted on carriage 13, via the interface 10, is tilted forward and backward as shown in FIGS. 2A and 2B.

In the embodiment shown in FIGS. 1, 2A & 2B, scissor movement of the interface sections 12 and 15 is effected by an electric motor and gearbox unit 20. The unit 20 is mounted on the rear upper edge of section 12. The output shaft 21 of the unit 20 preferably comprises a worm drive which engages in lead nut 23 mounted on the section 15. Thus operation of the motor/gearbox unit 20 moves the lead nut along output shaft 21. FIG. 2A shows the configuration of the levelling system when the lead nut is displaced to the outer end of output shaft 21, whilst FIG. 2B shows the position when the lead nut is fully drawn to the inner end of output shaft 21.

A number of alternative methods may be provided to control the operation of a levelling system according to the invention. One simple schematic form of control is shown in FIG. 2A and comprises a tilt sensor 25 giving an output signal which is fed into a form of signal processor 26. The signal processor then operates the motor 20 in response to the signal from sensor 25, to maintain or restore level.

As an alternative to the tilt sensor arrangement described above, a form of control operating substantially in the manner described in European Patent No. 0 738 232 could be employed. More particularly, at positions on the rail where the chair is caused to tilt, data representing the desired chair position, indexed to each of such positions, could be stored in electronic memory and used to operate the motor 20, to maintain level, as the carriage moves along the rail.

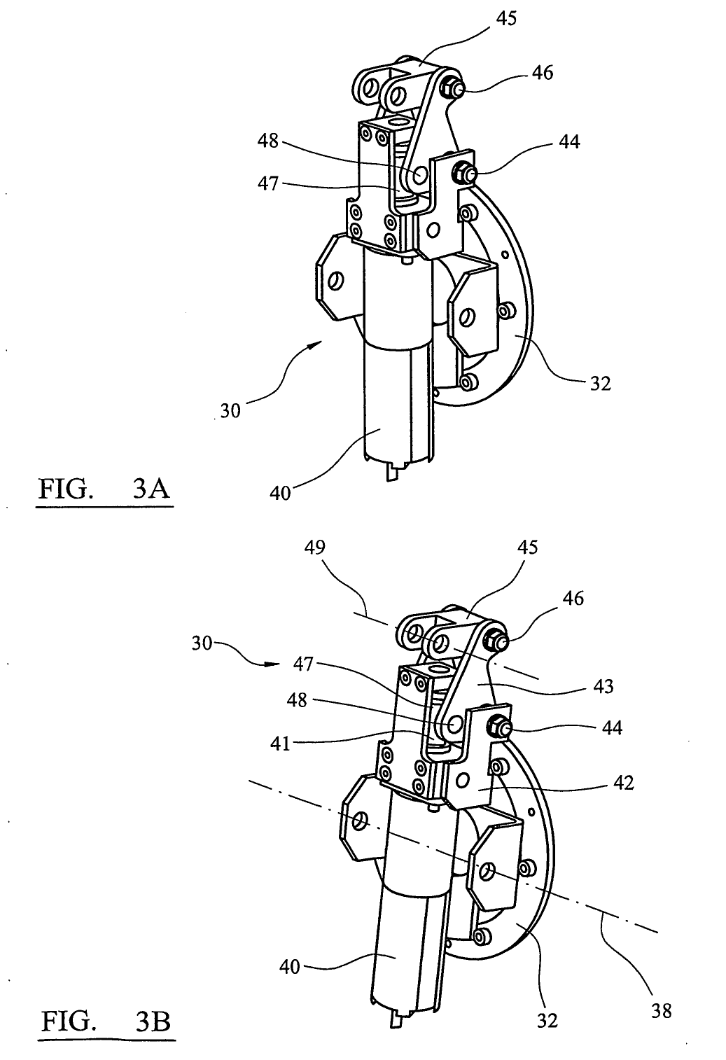

Turning now to FIGS. 3A, 3B & 4A, 4B, an arrangement of levelling interface is shown for use in those situations where space limitations may be a barrier to the use of the arrangement shown in FIGS. 1, 2A & 2B.

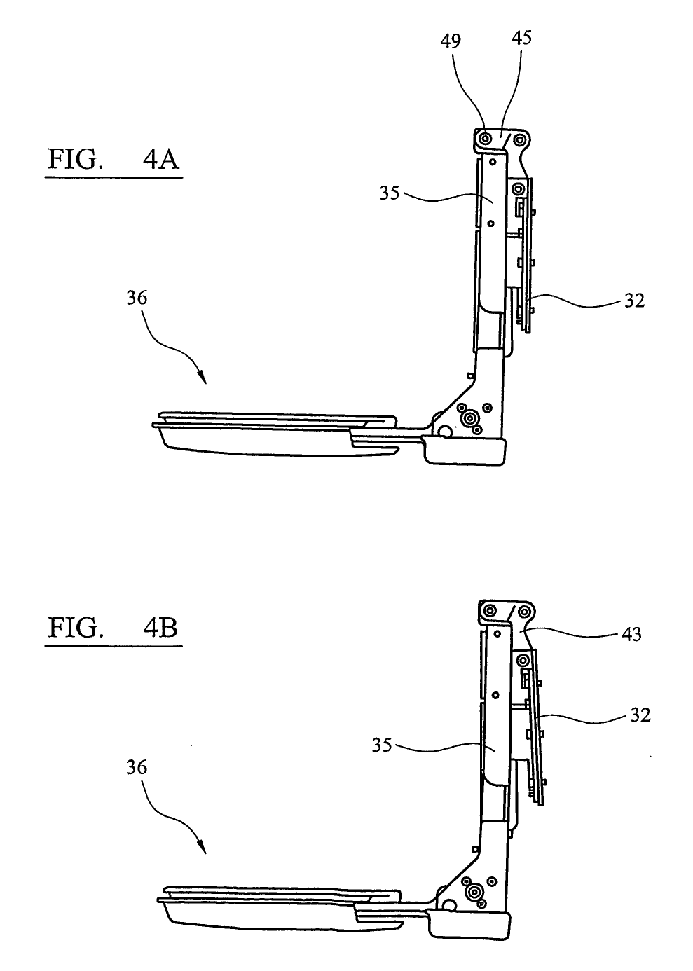

Referring to FIGS. 3A & 3B, the interface shown partly at 30 includes first section 32 mountable on to a stairlift carriage (not shown). The second section 35 on which the chair (shown partially at 36) is mounted, not shown for reasons of clarity in FIGS. 3A & 3B, is shown in FIGS. 4A & 4B. The sections 32 and 35 are mounted together to move in a scissor action, along axis 38.

In this particular embodiment the interface sections 32 and 35 are configured to allow the operating motor/gearbox unit 40 to be located there-between.

As can be seen, the motor/gearbox unit 40 is pivotally mounted to the section 32 via spaced side brackets 42. Also mounted to the side brackets 42 are a pair of bell cranks 43. The bell cranks 43 are pivoted to the brackets 42 at 44, and have a link 45 pivotally mounted at 46 to the uppers ends thereof.

Lead nut 47, displaced along the output shaft 41 of the motor/gearbox unit 40, is pivoted to the bell cranks 43 at 48. Link 45 is pivotally attached to section 35 of the interface, along axis 49. It will thus be appreciated that, as the nut 47 is displaced up and down output shaft 41, the bell cranks are rotated about axis 44 which displaces the axis 46 in a forward/rearward direction. This, in turn, pivots the chair with respect to the carriage, about axis 38.

The control of motor/gearbox 40 may be as described above.

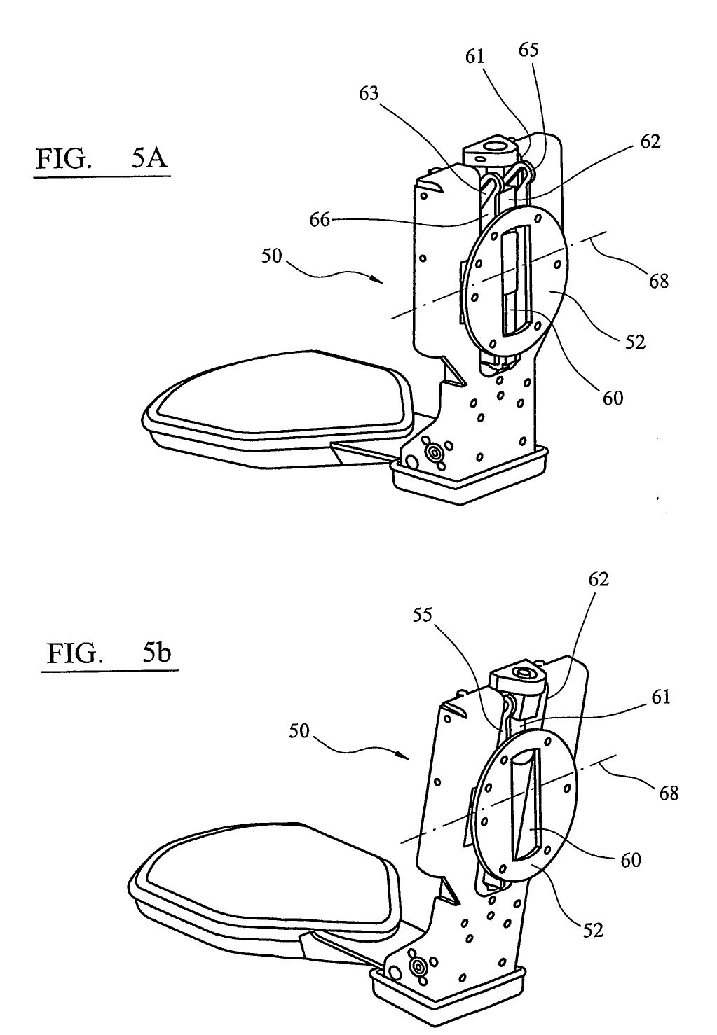

A further alternative tilting arrangement 50 is shown in FIGS. 5A & 5B. This arrangement is similar to the arrangement 30 described above, in that the drive motor/gearbox unit 60 is located between the sections 52 and 55 comprising the main interface sections. However, in place of the bell cranks, the output shaft 61 of unit 60 displaces a lead nut 62 having lugs 63 projecting from opposed side surfaces thereof. The lugs 64 project on a common transverse axis and engage in slots 65 provided in side plates 66 forming part of the interface section 55. It will be seen, particularly from FIG. 5A, that the slots are angled from the vertical. Thus, as the lead nut 62 moves up and down, the upper edges of the interface sections are moved towards and apart about axis 68.

It will thus be appreciated that the invention, at least in the case of the working embodiments herein described, provides a novel and effective means of maintaining a stairlift chair level irrespective of the vertical alignment of the rail. A particular advantage of the present invention is that it allows forward/rearward tilting of the chair to be provided as and when required and provides an assembly which can even be retrofitted.

1. A method of tilting a stairlift chair which is provided in an assembly including:
a stairlift rail;
a carriage mounted for movement along said rail;
a stairlift chair; and
a chair interface between said chair and said carriage to mount said chair on said carriage,
said method being characterised in that it comprises altering the configuration of said chair interface to tilt said chair with respect to said carriage.

2. A method as claimed in claim 1 further including sensing the level of said chair as said carriage moves along said rail, and altering the configuration of said chair interface in response to such sensing, if necessary, to restore the chair substantially to the level.

3. A method as claimed in claim 1 further including storing in an electronic memory information representing the desired alignment of the chair at various positions of the carriage along the rail and, as the carriage reaches a particular position on the rail, causing control means acting in response to the information in said memory to effect a change of configuration of said chair interface to achieve said desired alignment.

4. A stairlift assembly including:
a stairlift rail;
a carriage mounted for movement along said rail;
a stairlift chair;
a chair interface between said chair and said carriage to mount said chair on said carriage,
said assembly being characterised in that the configuration of said chair interface is alterable to effect tilting of said chair with respect to said carriage.

5. A chairlift assembly as claimed in claim 4 wherein said interface includes two parts pivoted together to form scissor arms, one of said scissor arms being mounted to said carriage and the other of said scissor arms being mounted to said chair.

6. A chairlift assembly as claimed in claim 4 wherein said interface further includes an electric motor to, in use, effect alteration of the configuration of said interface.

7. A chairlift assembly as claimed in claim 6 wherein said electric motor is located between the two parts comprising said interface.

8. A chair interface for mounting between a stairlift carriage and a stairlift chair, said chair interface being characterized in that the configuration thereof can, in use, be altered to effect tilting of said chair with respect to said carriage.
